(19) United States
(12) Patent Application Publication
(10) Pub. No.: US 2021/0388249 A1
(43) Pub. Date: Dec. 16, 2021

(54) ABRASIVE POWDERS IN SOFT MATRICES

(71) Applicant: Yefim Kats, Brooklyn, NY (US)

(72) Inventor: Yefim Kats, Brooklyn, NY (US)

(21) Appl. No.: 16/902,736

(22) Filed: Jun. 16, 2020

(51) Int. Cl. C09K 3/14; B24B 37/24; B24B 3/36

(52) U.S. Cl. CPC C09K 3/1409; B24B 3/366; B24B 37/245

(57) ABSTRACT

The invention is an abrasive article for sharpening cutting blades mounted within a grinding apparatus. The article is a soft matrix in which are embedded abrasive particles, and this matrix is preferably encased within a dry and non-adherent shell or capsule. The article is capable of being fed into the apparatus, wherein it is crushed, leaving the abrasive particles free to contact and sharpen the blades by abrasion.

### FIELD OF THE INVENTION

This invention relates to abrasive powders for grinding and sharpening, more specifically, abrasive powders rendered more convenient for use by being embedded in a soft matrix.

### BACKGROUND

The use of abrasive powders for the shaping and sharpening of cutting blades is an old and well-developed technology. Powders of various particle sizes and hardness continue to be developed, as workers in the field seek improvements in cost effectiveness and efficiency. Dry abrasive powders, especially the finer grades having very small particle sizes, are difficult to meter out and difficult to keep in place on the surface being worked, and such powders are typically provided in the form of liquid or paste suspensions, or embedded in a solid carrier. Such fluids, pastes and solids are easily contained and easily dispensed, and may incorporate useful additives such as lubricants, dispersants, and rhreological control agents. It is common to incorporate colorants to enable a practitioner to recognize the grade and type of abrasive.

Prior art pastes and fluids are suitable for delivering abrasive powders to most surfaces, but there are devices in which blades that require sharpening are not so easily accessed. These devices, in general, must be disassembled before the cutting surfaces of the blades can be worked on, and then re-assembled after sharpening is complete. A meat grinder, of the sort having a rotating cruciform cutting blade encased within a housing, is one particular example of such a device.

The blade of a meat grinder is ordinarily removed from its arbor by disassembling the grinder. The blade is then manually sharpened with a natural or synthetic sharpening stone. Specific tools for this purpose are known, as described for example in U.S. Pat. No. 2,410,955. The above-mentioned paste or fluid suspensions of abrasive powders can be easily employed at this stage. More recently, a method of sharpening that employs a sharpening stone configured to be installed within the grinder has been described in U.S. Patent Application Publication No. 2018/0215004. Use of this method, however, still involves disassembly and reassembly of the grinder.

There remains a need for a quick and convenient method of sharpening internally-mounted blades, such as those of meat grinders, that does not require disassembly of the apparatus and removal of the blade.

### SUMMARY OF THE INVENTION

The invention provides an abrasive powder, having a particle size and hardness suitable for sharpening a blade, which is embedded in a soft solid or semi-solid matrix. The soft matrix containing the powder is provided in a divided form, such as granules or beads (the “articles” of the invention), which are of a size that is convenient for feeding into the apparatus that contains the blade. In a preferred embodiment, the apparatus is a meat grinder having an auger, and a rotating blade held against a hole plate. The articles of the invention are fed to the blade via the auger, so that they are crushed between the blade and the hole plate. The embedded powder particles are thereby pressed between the surfaces of the blade and the surface of the hole plate (the “substrate surfaces”), where continued operation of the grinder results in abrasion of the surfaces, thereby effecting the sharpening of the blade.

The divided form of the matrix preferably takes the form of spherical or ellipsoidal beads. The size of the beads is not critical: they should be of a size that is not too large to be engaged by the auger of the grinder, and not so small that they pass through the hole plate intact. The divided form preferably has a firm, dry surface that prevents aggregation of the beads or granules, so that in bulk, the divided form can be easily poured or shaken out of a container and into the mouth of the grinder. This outer surface may be provided by an applied coating or by a capsule containing the soft matrix.

### BRIEF DESCRIPTION OF THE FIGURES

FIG. 1 is a cross-section of a representative article of the invention, with a magnified section shown.

### DETAILED DESCRIPTION OF THE INVENTION

The abrasive powder can be made of any hard material known to be useful for sharpening blades. Examples include, but are not limited to, pumice, emery, corundum, carborundum, alumina, silica, boron carbide, boron nitride, diamond, and the various metal nitrides and carbides known in the art. The average size of the powder particles may range from 5 to 200 microns, and is preferably from 20 to 100 microns. Because an abrasive particle can be effective only if it contacts both the surface of the blade and the surface of the hole plate, a narrow distribution of particle sizes is preferred. The abrasive effect of the particles is reduced if the particles roll between the substrate surfaces, and for this reason it is preferred that the particles have a plate-like morphology, which favors a more effective sliding motion across the substrate surface.

The soft matrix may take the form of a plastic, viscoelastic, or viscous fluid that is soft enough to be processed by the device. For example, it should be capable of being transported by the augur, cut by the blade, and forced through the hole plate of a meat grinder. For use in meat grinders, the soft matrix is preferably water-soluble or water-dispersible, so that it can be easily rinsed from the grinder. Edible gels and gums are particularly preferred. Suitable water-soluble or water-dispersible materials include but are not limited to modified starches, sodium carboxymethyl cellulose, hydroxypropyl cellulose, acacia, tragacanth, pectin, gelatin, agar, polyethylene glycol, poly(vinyl pyrrolidone), sodium polyacrylate, and poly(vinyl alcohol).

The articles of the invention may comprise an outer shell or capsule enclosing the soft matrix. The outer shell or capsule provides a dry, non-adherent surface, capable of substantially preventing the articles from sticking to one another. Suitable materials for the shell or capsule include but are not limited to gelatin, rosin and modified rosins, modified starches, and sugars.

The articles of the invention may be prepared by kneading a mixture of the abrasive powder and the soft matrix until the powder is evenly distributed. The mixture may then be extruded and cut into segments having the desired volume. The matrix material may be softened by heating, to aid in the distribution of the powder and/or the extrusion process.

In certain embodiments, the matrix material, upon cooling, yields articles that are firm and non-sticky enough to remain loose in storage. In other embodiments, the matrix material can be heated until fluid, and injected into gelatin capsules. In yet other embodiments, the cut segments can be coated with an encapsulating agent, such as a sugar-, starch-, rosin-, or gelatin-based coating, that is hardened after application by cooling and/or by solvent evaporation. Methods for encapsulating or coating soft materials in a hard, non-adherent coating are well-known in the pharmaceutical and confectionary arts, and can readily be adapted to the soft matrices of the invention; accordingly, the present invention is not limited to any particular coating or encapsulating materials or methods.

In use, articles of the invention are fed into the auger of the grinder, and the grinder is operated until the articles are crushed and the soft matrix appears at the outlets of the hole plate. The grinder is preferably then operated, alternately, in the forward and reverse directions. Sharpening is most effective when the grinder is operated in reverse, as this allows the blade to ride up and over the abrasive particles, rather than scraping them away from the hole plate as it would tend to do in forward operation. Thus, the most preferred method of use involves alternating between short periods in the forward direction, to feed fresh abrasive to the substrate surfaces, and longer periods in the reverse direction to effect abrasion and sharpening. When all of the matrix has been run through the grinder, it can then be operated in the forward direction, with a flow of water through the device, until the grinder is free of abrasive particles.

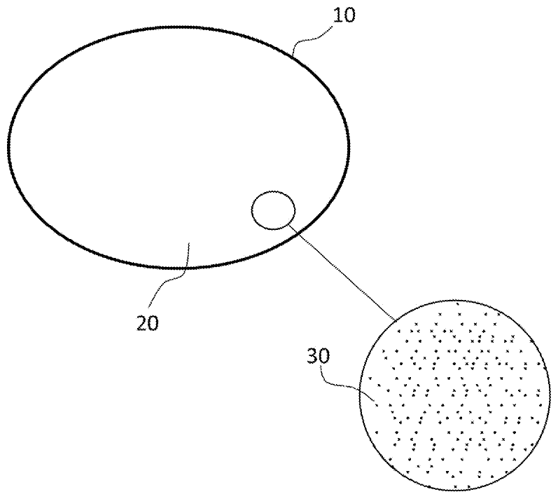

FIG. 1 shows a representative article of the invention, illustrating a shell or coating 10 surrounding a soft matrix material 20. A magnified portion of the matrix is illustrated, in which abrasive particles 30 are shown suspended and substantially evenly distributed. The particles as shown are not intended to be to scale, relative to the section being magnified, but are sized for convenience in illustrating the invention.

The illustrations provided in the drawings, and descriptions provided by this specification, are intended as representative examples; accordingly the invention is not limited to the described and/or illustrated embodiments. Those of skill in the art can readily envision obvious equivalents and alternatives to the specific embodiments of the invention described herein, and such obvious equivalents and alternatives are contemplated by the inventor to be embodiments of the present invention. No disclaimer of any such equivalents and alternatives, explicit or implied, is intended to be made by the present disclosure or by the drawings. The scope of the claims appended hereto should, accordingly, be understood to encompass any and all such equivalents and alternatives.

1. An abrasive composition, comprising abrasive particles distributed within a soft, water-soluble matrix; the matrix being divided into individual articles having a mean diameter between about 4 mm and about 20 mm.

2. The abrasive composition according to claim 1, wherein the abrasive particles have a mean diameter between 1.0 and 100 microns.

3. The abrasive composition according to claim 1, wherein the matrix is divided into articles having a mean diameter between about 4 mm and about 15 mm.

4. The abrasive composition according to claim 2, wherein the matrix is divided into articles having a mean diameter between about 4 mm and about 15 mm.

5. The abrasive composition according to claim 1, wherein the articles further comprise a hard coating.

6. The abrasive composition according to claim 2, wherein the articles further comprise a hard coating.

7. The abrasive composition according to claim 3, wherein the articles further comprise a hard coating.

8. The abrasive composition according to claim 4, wherein the articles further comprise a hard coating.

9-16. (canceled)
